(19) United States
(12) Patent Application Publication
(10) Pub. No.: US 2016/0167555 A1
(43) Pub. Date: Jun. 16, 2016

(54) TRAY TABLE ASSEMBLY

(71) Applicant: ZODIAC SEATS US LLC, Gainesville, TX (US)

(72) Inventors: John D. Allen, Sanger, TX (US); Guorong Zhu, Ontario (CA)

(21) Appl. No.: 14/907,352

(22) PCT Filed: Jul. 24, 2014
(86) PCT No.: PCT/US2014/047972

§ 371 Date: Jan. 25, 2016

Related U.S. Application Data
(60) Provisional application No. 61/857,759, filed on Jul. 24, 2013.

(51) Int. Cl. B60N 3/00; B64D 11/06

(52) U.S. Cl. CPC B60N 3/004; B64D 11/0638

(57) ABSTRACT

Described are tray table assemblies that include a tray table (26) and at least one tray table arm (24) pivotally coupled to the tray table proximate a pivot location (22). As examples, the tray table is configured to stow within a stowage compartment, and the tray table arm is pivotally coupled to the stowage compartment proximate a second pivot location. A torque insert (12) is positioned within the one or both pivot locations.

### CROSS REFERENCE TO RELATED APPLICATIONS

This application is related to and claims priority benefits from U.S. Provisional Application Ser. No. 61/857,759 (“the '759 application”), filed on Jul. 24, 2013, entitled One-Way Torque Hinge Application in Food Table Aircraft Seat. The '759 application is hereby incorporated in its entirety by this reference.

### FIELD OF THE INVENTION

The invention relates to tray tables for use with passenger seats or the like.

### BACKGROUND

Many passenger seats such as those on passenger aircraft, buses, trains, and the like are arranged so that each passenger seat, other than the forward-most located passenger seats, faces the back of the next forward passenger seat. To increase a passenger's comfort and enjoyment, tray tables may be installed for the passenger's use during the trip. Typically, the tray table is stowed either on the aft side of the passenger seat back (in front of the passenger in the next row) or below an arm rest (also known as an in-arm tray table). The tray table may be deployed by the passenger to provide a relatively flat surface for eating, working, recreation, or other uses.

To deploy the back-mounted tray table, the passenger unlatches the tray table from the passenger seat back, which allows the tray table to rotate away from the seat back via tray table arms that are pivotally coupled to the passenger seat back below the tray table. The tray table then rotates into a substantially horizontal position relative to the tray table arms for use by the passenger. When not in use by the passenger, the tray table is stowed against the seat back and held in place via conventional latching techniques.

To deploy the in-arm tray table, the passenger raises an arm rest cover to access the tray table, rotates the tray table from a stowed position within a stowage compartment until the tray table reaches a raised position, then rotates the tray table to a deployed position in front of the passenger.

In certain situations, however, the back-mounted tray tables may inadvertently deploy from the stowed position without passenger initiation, also known as “free falling.” Typically, such inadvertent deployment occurs during crashes, but may also occur during other types of events that may apply a force to the latch holding the tray table in the stowed position. Inadvertent deployment of a tray table during or immediately following a crash or at other times may restrict an exit pathway from the vehicle and/or hinder movement of passengers.

During turbulence or other disturbances, both the in-arm and back-mounted tray tables may inadvertently lift from the deployed position without passenger initiation, also known as “free lifting.”

Furthermore, when a passenger is deploying or stowing the in-arm tray table relative to the stowage compartment below the arm rest, the passenger may inadvertently drop the tray table into the stowage compartment, which can result in a loud noise as the in-arm tray table falls into the stowage compartment and/or may result in damage to the tray table or the stowage compartment.

Thus, it may be desirable to provide tray table rotational damping capability to avoid tray table free falling and/or free lifting without torque force.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments of the present invention, a tray table assembly comprises a tray table, at least one tray table arm pivotally coupled to the tray table proximate a pivot location, and at least one torque insert positioned within the pivot location.

The at least one torque insert may comprise a housing that is fixedly coupled to the at least one tray table arm and an adaptor that is press fitted into the tray table. In some embodiments, the tray table further comprises a mechanical stop that is inserted within a slot on the at least one tray table arm.

In some embodiments, the tray table assembly is pivotally coupled to a passenger seat back. The at least one torque insert may be configured to resist rotation of the tray table when the tray table is rotated into a deployed position away from the passenger seat back. The at least one torque insert may also be configured to resist rotation of the tray table when the tray table is rotated into a stowed position adjacent the passenger seat back.

According to certain embodiments of the present invention, a tray table assembly comprises a tray table configured to stow within a stowage compartment, a tray table arm pivotally coupled to the tray table proximate a first pivot location, and the tray table arm pivotally coupled to the stowage compartment proximate a second pivot location, wherein a torque insert is positioned within each of the first and second pivot locations.

In some embodiments, the torque insert positioned within the first pivot location is configured to resist rotation of the tray table when the tray table is rotated into a deployed position, and the torque insert positioned within the second pivot location is configured to resist rotation of the tray table arm when the tray table is rotated into the stowage compartment. The torque insert positioned within the first pivot location may also be configured to resist rotation of the tray table when the tray table is rotated into a stowed position, and the torque insert positioned within the second pivot location is also configured to also resist rotation of the tray table arm when the tray table is rotated away from the stowage compartment.

In certain embodiments, the torque insert positioned within the second pivot location is configured to resist rotation of the tray table arm when the tray table is rotated into the stowage compartment and to also resist rotation of the tray table arm when the tray table is rotated away from the stowage compartment.

According to certain embodiments of the present invention, a tray table assembly comprises a tray table pivotally coupled to at least one tray table arm via at least one torque insert, wherein the at least one torque insert is configured to resist rotation of the tray table when the tray table is rotated into a deployed position.

In some embodiments, the at least one torque insert comprises a housing that is fixedly coupled to the at least one tray table arm and an adaptor that is press fitted into the tray table. The tray table may further comprise a mechanical stop that is inserted within a slot on the at least one tray table arm. The at least one torque insert may also be configured to resist rotation of the tray table when the tray table is rotated into a stowed position.

In some embodiments, the at least one tray table arm is pivotally coupled to a passenger seat back. In other embodiments, the at least one tray table arm is pivotally coupled to a stowage compartment of a passenger seat via a second torque insert. In these embodiments, the second torque insert may be configured to resist rotation of the at least one tray table arm when the tray table is rotated into the stowage compartment. In other embodiments, the second torque insert may be configured to resist rotation of the at least one tray table arm when the tray table is rotated away from the stowage compartment.

According to certain embodiments of the present invention, a tray table assembly comprises a tray table configured to stow within a stowage compartment, a tray table arm pivotally coupled to the tray table proximate a first pivot location, and the tray table arm pivotally coupled to the stowage compartment proximate a second pivot location, wherein a torque insert is positioned within the second pivot location.

In these embodiments, the torque insert positioned within the second pivot location may be configured to resist rotation of the tray table arm when the tray table is rotated into the stowage compartment and to also resist rotation of the tray table arm when the tray table is rotated away from the stowage compartment.

### BRIEF DESCRIPTION OF THE DRAWINGS

FIG. 1 is a perspective view of a tray table assembly coupled to a passenger seat back, according to certain embodiments of the present invention.

FIG. 2A is a side view of the tray table assembly with a bi-fold portion of the tray table in a folded position, showing directions of rotation between stowed and deployed positions.

FIG. 2B is a side view of the tray table assembly with a single panel tray table, showing the directions of rotation between stowed and deployed positions.

FIG. 3 is a perspective view of a portion of the tray table assembly of FIG. 1.

FIG. 4 are orthogonal views of a torque insert for use with a tray table assembly, according to certain embodiments of the present invention.

FIG. 5 are orthogonal views of the torque insert of FIG. 4 in use with a pivot block, according to certain embodiments of the present invention.

FIG. 6 is a perspective view of a tray table assembly pivotally coupled to a stowage compartment of a passenger seat, according to certain embodiments of the present invention.

FIG. 7 is a perspective view of the tray table assembly of FIG. 6 with the tray table rotated in a longitudinal direction out of the stowage compartment.

FIG. 8 is a perspective view of the tray table assembly of FIG. 6 with the tray table rotated laterally into a deployed position and a bi-fold portion of the tray table in a folded position.

FIG. 9 is a perspective view of the tray table assembly of FIG. 6 with the tray table rotated laterally into a deployed position and a bi-fold portion of the tray table in a deployed position.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

The described embodiments of the invention provide tray table assemblies for use with passenger seats. While the tray table assemblies are discussed for use with aircraft seats, they are by no means so limited. Rather, embodiments of the tray table assemblies may be used in passenger seats or other seats of any type or otherwise as desired.

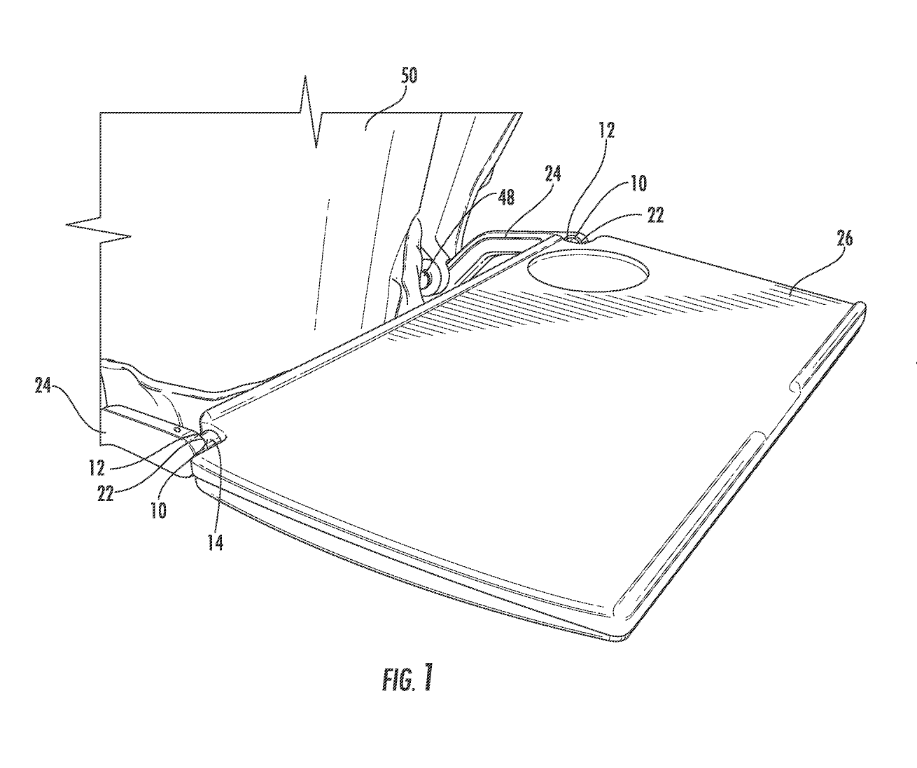

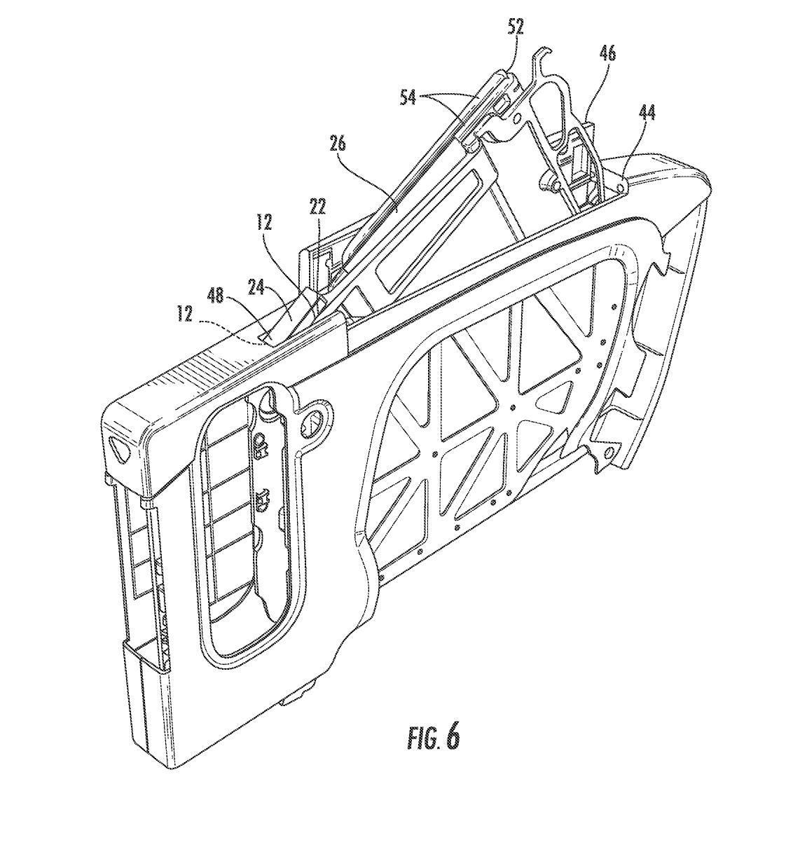

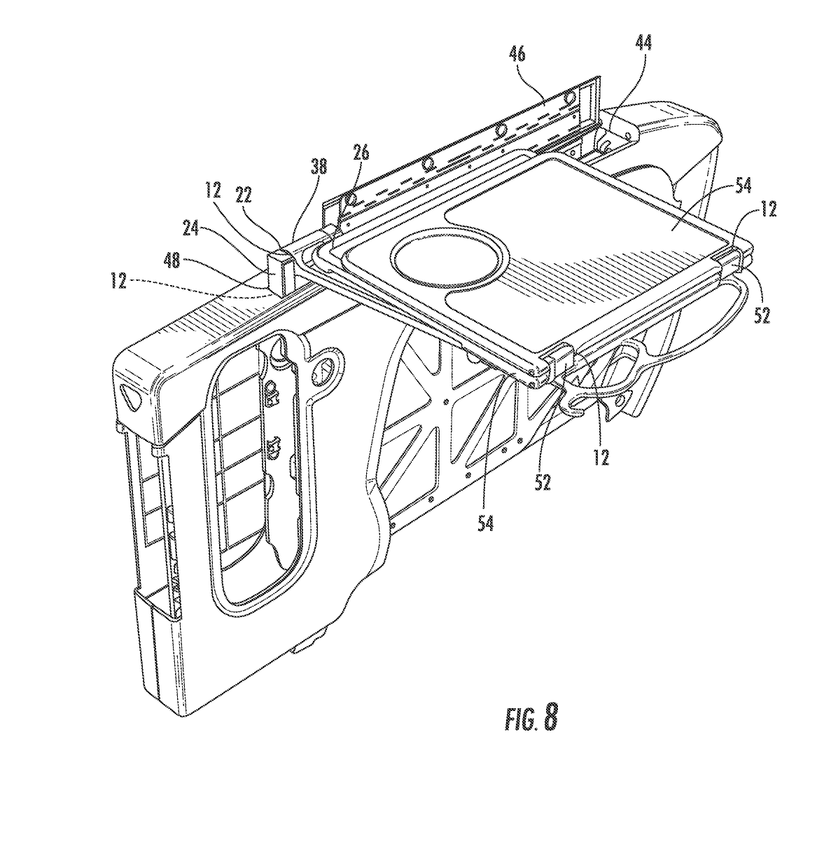

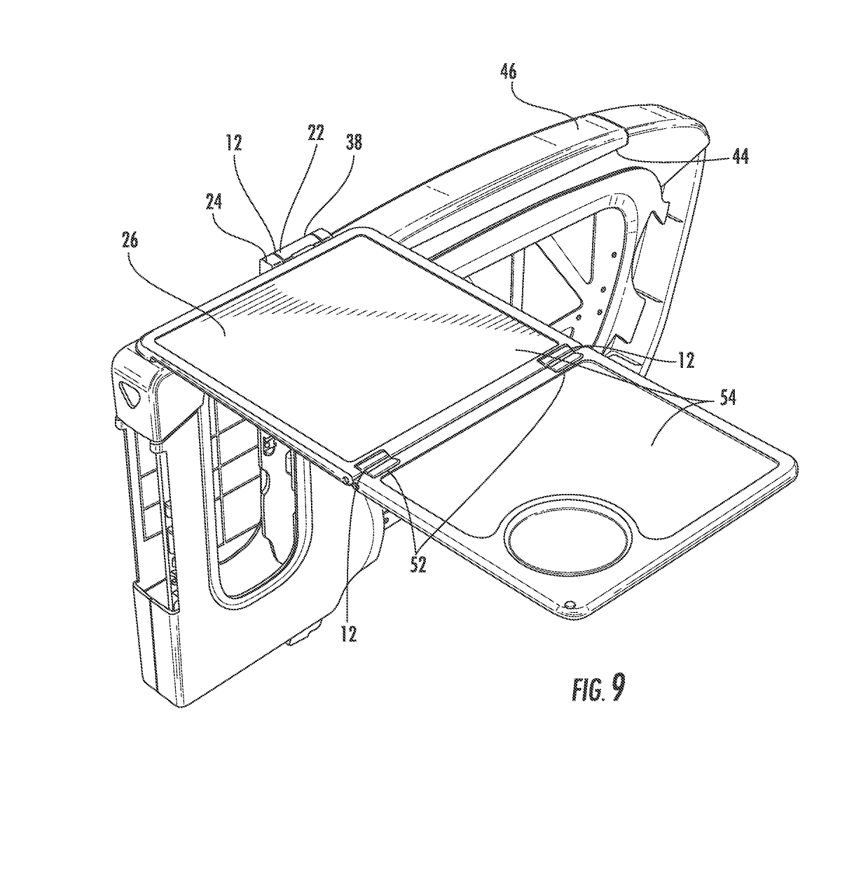

FIGS. 1-9 illustrate embodiments of a tray table assembly 10. In these embodiments, the tray table assembly 10 comprises a tray table 26, at least one tray table arm 24, and at least one torque insert 12.

In these embodiments, as shown in FIG. 4, the torque insert 12 comprises a housing 14 that encloses a plurality of clips 18 that provide torque in one or both rotational directions of a shaft 20 that rotates within the clips 18. An adaptor 16 that is configured for press fitting into plastics or other similar materials may be positioned over an exposed end of the shaft 20. In certain embodiments, the adaptor 16 may have a knurled surface that prevents the adaptor 16 from rotating within an aperture into which it is press fitted. In some embodiments, additional bonding or other chemical adhesives may be used to ensure that the adaptor 16 is fixedly coupled to the aperture into which it is press fitted. The details of the internal components of the torque insert 12 are described in detail in U.S. Pat. No. 5,697,125, the entire contents of which is incorporated herein by reference. In certain embodiments, the amount of torque applied by the torque insert 12 may range from 0.5 N-m to 10 N-m.

In these embodiments, the tray table 26 is pivotally coupled to a passenger seat 50 via at least one tray table arm 24. In the back-mounted embodiments, the tray table 26 is pivotally coupled to a pair of tray table arms 24, which are in turn pivotally coupled to the passenger seat 50. In the in-arm embodiments, the tray table 26 is pivotally coupled to a tray table arm 24, which is in turn pivotally coupled to a stowage compartment 44 located below an arm rest 46 of the passenger seat 50.

In these embodiments, the torque insert 12 may be positioned within one or both pivot locations 22 located between the tray table 26 and one or both tray table arms 26. Further, in certain embodiments, the torque insert 12 may be positioned within one or both pivot locations 48 located between the tray table arm 26 and the passenger seat 50 (or the stowage compartment 44).

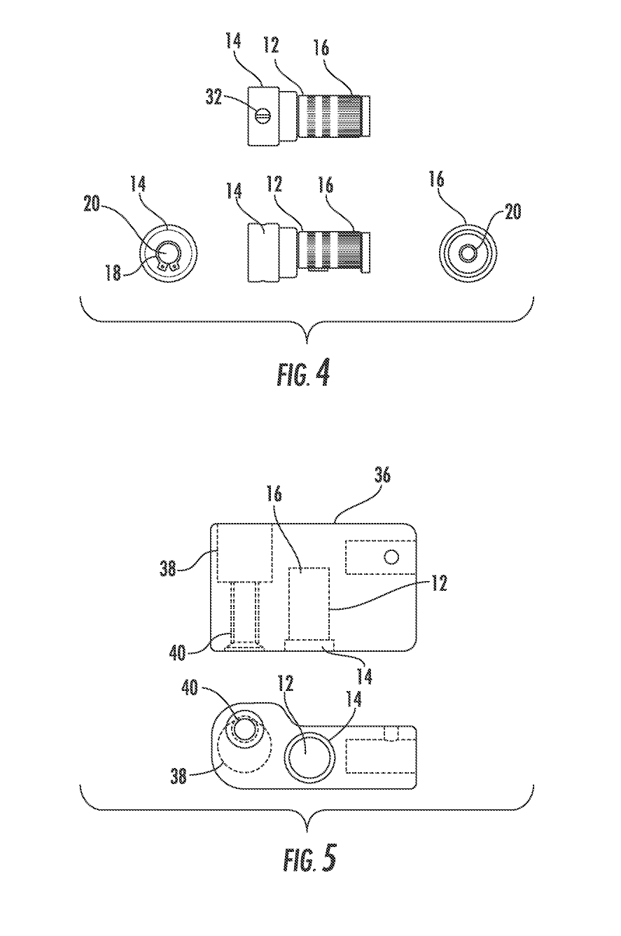

For example, with respect to the pivot location 22, as best illustrated in FIG. 3, the housing 14 of the torque insert 12 may be mounted within an aperture 28 located in an end 30 of the tray table arm 24. A set screw 32 may be inserted through an opening 34 in the aperture 28 to secure the housing 14 of the torque insert 12 to the tray table arm 24 and to prevent the torque insert 12 from rotating within the aperture 28. The adaptor 16 of the torque insert 12 is then press fitted into the tray table 26, which may be further secured using an adhesive or any suitable chemical fastener. The details described herein of how the torque insert 12 is inserted within the pivot location 22 in the back-mounted embodiments is but one exemplary fastening design. A person of ordinary skill in the relevant art will understand that the torque insert 12 may be similarly inserted within other pivot locations 22, 48, 52 using similar or different designs.

In certain back-mounted embodiments, as shown in FIGS. 1-3 and 5, the adaptor 16 of the torque insert 12 may be press fitted within a pivot block 36, and a pivot bar 38 of the tray table 26 may also be coupled to the pivot block 36. In certain embodiments, a mechanical stop 40 may also be coupled to the pivot block 36 and/or as an extension of the pivot bar 38. The stop 40 protrudes from the pivot block 36 adjacent the torque insert 12 and engages a slot 42 in the tray table arm 24 to limit the range of travel of the tray table 26 relative to the tray table arm 24.

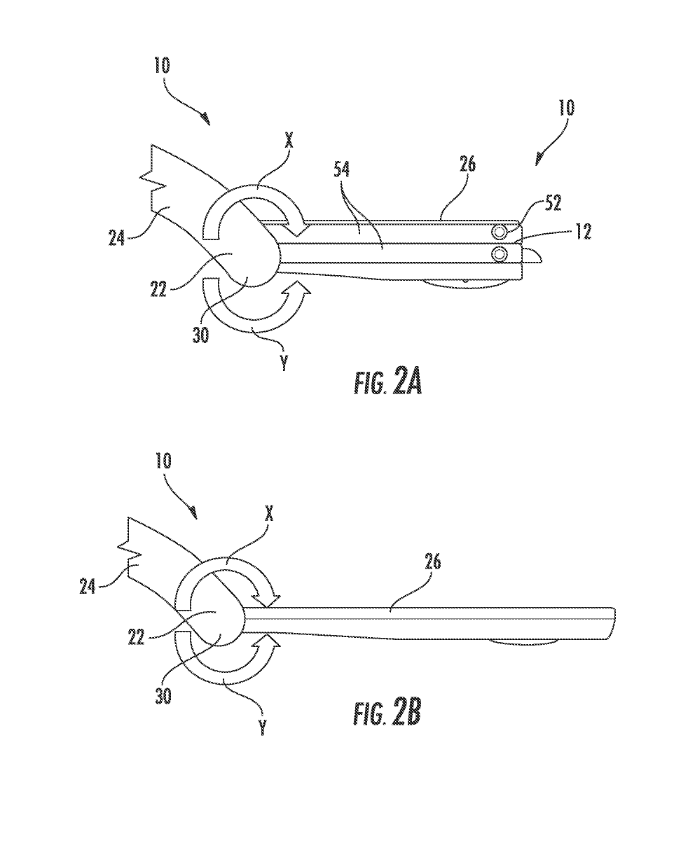

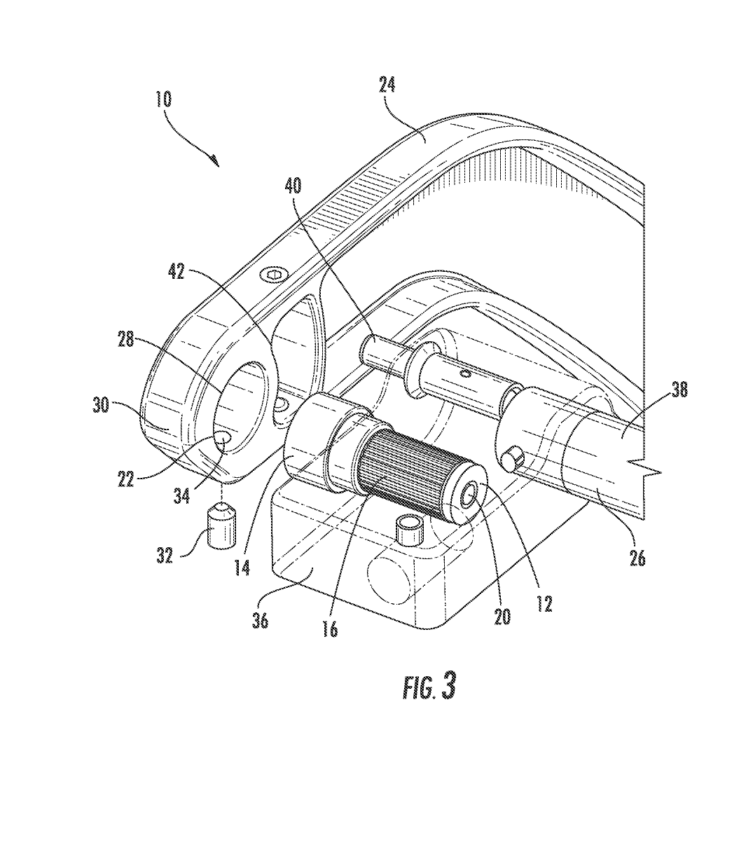

In these back-mounted embodiments, as best illustrated in FIGS. 2A and 2B, the torque insert 12 that is inserted within the pivot location 22 may be configured to resist rotation (i.e. create torque) when the tray table 26 is rotated into a deployed position (as shown by arrow “X”) so as to prevent the tray table 26 from “free falling” from its stowed position, while also being configured not to resist rotation (i.e. allow free rotation) when the tray table 26 is rotated into a stowed position (as shown by arrow “Y”). In other words, the torque insert 12 may be a “one-way” torque insert 12 in these embodiments.

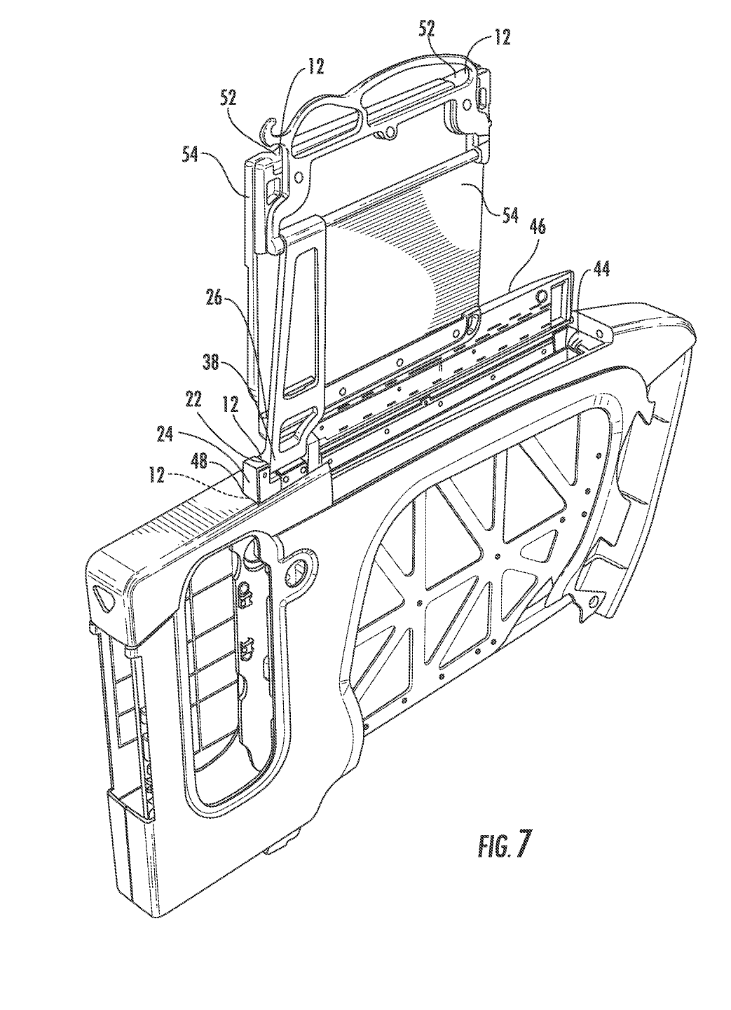

In the in-arm embodiments, as best illustrated in FIGS. 6-9, the torque insert 12 that is inserted within the pivot location 22 may be configured to resist rotation (i.e. create torque) when the tray table 26 is rotated laterally into a deployed position over a passenger's lap seated in the passenger seat 50 so as to prevent the tray table 26 from “free falling” from its stowed position, while also being configured to resist rotation (i.e. create torque) when the tray table 26 is rotated laterally away from the passenger's lap seated in a passenger seat 50 and into a vertical position above the stowage compartment 44. In other words, the torque insert 12 may be a “two-way” torque insert 12 in these embodiments.

However, a person of ordinary skill in the relevant art will understand that any suitable torque insert design may be used in the pivot locations 22 (in both the back-mounted and in-arm embodiments) including but not limited to a one-way torque insert 12 (with the torque applied in either rotational direction), a two-way torque insert 12, and/or a torque insert 12 with higher or lower applied torque, as appropriate or desired in these or other applications with tray tables 26.

In the in-arm embodiments, as shown in FIGS. 6-9, the tray table 26 is stowed within the stowage compartment 44 below the arm rest 46. As a result, the tray table 26 deploys from the stowage compartment 44 by rotating the tray table 26 in a longitudinal direction out of the stowage compartment 44. To prevent the tray table 26 from “free-falling” into the stowage compartment 44 (due to being inadvertently dropped by the passenger while trying to deploy the tray table 26 or by a passenger simply letting go of the tray table 26 to allow the tray table 26 to finish rotating into the stowage compartment 44), at least one additional torque insert 12 may be positioned within the pivot location 48 located between the tray table arm 24 and the stowage compartment 44. In certain embodiments, some or all of the details of how the torque insert 12 is positioned within the pivot location 48 are the same as those described above with respect to how the torque insert 12 is positioned within the pivot location 22 located between the tray table 26 and the tray table arm 24.

In these embodiments, the additional torque insert 12 that is positioned within the pivot location 48 may be configured to resist rotation (i.e. create torque) of the tray table arm 24 when the tray table 26 is rotated into the stowage compartment 44 to prevent the tray table 26 from “free falling” into the stowage compartment 44, while also being configured to resist rotation (i.e. create torque) of the tray table arm 24 when the tray table 26 is rotated away from the stowage compartment 44 and into a vertical position above the stowage compartment 44. In other words, the torque insert 12 may be a “two-way” torque insert 12 in these embodiments.

However, a person of ordinary skill in the relevant art will understand that any suitable torque insert design may be used in the pivot location 48 including but not limited to a one-way torque insert 12 (with the torque applied in either rotational direction) and/or a torque insert 12 with higher or lower applied torque, as appropriate or desired in these or other applications with tray tables 26.

In yet other embodiments, at least one further torque insert 12 may be used in bi-fold tray table 26 applications, such as the embodiments shown in FIG. 2A (back-mounted version) and FIGS. 6-9 (in-arm version). In these embodiments, the torque insert 12 may be positioned within one or more pivot locations 52 located between foldable portions 54 of the tray table 26. In certain embodiments, some or all of the details of how the torque insert 12 is positioned within the pivot location 52 are the same as those described above with respect to how the torque insert 12 is positioned within the pivot location 22 located between the tray table 26 and the tray table arm 24.

In these bi-fold tray table 26 embodiments, the torque insert 12 that is inserted within the pivot location 52 may be configured to resist rotation (i.e. create torque) when one of the portions 54 is rotated into a folded position so as to prevent unintended “free lift” of the tray table 26 when in the deployed position, while also being configured not to resist rotation (i.e. allow free rotation) when one of the portions 54 is rotated into a deployed position. In other words, the torque insert 12 may be a “one-way” torque insert 12 in these embodiments.

In other embodiments, the one-way configuration of the torque insert 12 may be reversed, so as to not resist rotation (i.e. allow free rotation) when one of the portions 54 is rotated into a folded position, while configured to resist rotation (i.e. create torque) when one of the portions 54 is rotated into a deployed position so as to prevent unintended “free fall” into the deployed position. In yet other embodiments, the torque insert 12 may be two-way, so as to resist rotation (i.e. create torque) when one of the portions 54 is rotated into the folded position and the deployed position. A person of ordinary skill in the relevant art will understand that any suitable torque insert design may be used in the pivot location 52 including but not limited to any of the embodiments described above, and/or a torque insert 12 with higher or lower applied torque, as appropriate or desired in these or other applications with tray tables 26.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

That which is claimed is:

1. A tray table assembly comprising:
a tray table;
at least one tray table arm pivotally coupled to the tray table proximate a pivot location; and
at least one torque insert positioned within the pivot location.

2. The tray table assembly of claim 1, wherein the at least one torque insert comprises a housing that is fixedly coupled to the at least one tray table arm and an adaptor that is press fitted into the tray table.

3. The tray table assembly of claim 1, wherein the tray table further comprises a mechanical stop that is inserted within a slot on the at least one tray table arm.

4. The tray table assembly of claim 1, wherein the tray table assembly is pivotally coupled to a passenger seat back.

5. The tray table assembly of claim 4, wherein the at least one torque insert is configured to resist rotation of the tray table when the tray table is rotated into a deployed position away from the passenger seat back.

6. The tray table assembly of claim 5, wherein the at least one torque insert is also configured to resist rotation of the tray table when the tray table is rotated into a stowed position adjacent the passenger seat back.

7. A tray table assembly comprising:
a tray table configured to stow within a stowage compartment;
a tray table arm pivotally coupled to the tray table proximate a first pivot location; and
the tray table arm pivotally coupled to the stowage compartment proximate a second pivot location;
wherein a torque insert is positioned within each of the first and second pivot locations.

8. The tray table assembly of claim 7, wherein the torque insert positioned within the first pivot location is configured to resist rotation of the tray table when the tray table is rotated into a deployed position, and the torque insert positioned within the second pivot location is configured to resist rotation of the tray table arm when the tray table is rotated into the stowage compartment.

9. The tray table assembly of claim 8, wherein the torque insert positioned within the first pivot location is also configured to resist rotation of the tray table when the tray table is rotated into a stowed position, and the torque insert positioned within the second pivot location is also configured to also resist rotation of the tray table arm when the tray table is rotated away from the stowage compartment.

10. The tray table assembly of claim 7, wherein the torque insert positioned within the second pivot location is configured to resist rotation of the tray table arm when the tray table is rotated into the stowage compartment and to also resist rotation of the tray table arm when the tray table is rotated away from the stowage compartment.

11. A tray table assembly comprising:
a tray table pivotally coupled to at least one tray table arm via at least one torque insert;
wherein the at least one torque insert is configured to resist rotation of the tray table when the tray table is rotated into a deployed position.

12. The tray table assembly of claim 11, wherein the at least one torque insert comprises a housing that is fixedly coupled to the at least one tray table arm and an adaptor that is press fitted into the tray table.

13. The tray table assembly of claim 11, wherein the tray table further comprises a mechanical stop that is inserted within a slot on the at least one tray table arm.

14. The tray table assembly of claim 11, wherein the at least one torque insert is also configured to resist rotation of the tray table when the tray table is rotated into a stowed position.

15. The tray table assembly of claim 11, wherein the at least one tray table arm is pivotally coupled to a passenger seat back.

16. The tray table assembly of claim 11, wherein the at least one tray table arm is pivotally coupled to a stowage compartment of a passenger seat via a second torque insert.

17. The tray table assembly of claim 16, wherein the second torque insert is configured to resist rotation of the at least one tray table arm when the tray table is rotated into the stowage compartment.

18. The tray table assembly of claim 16, wherein the second torque insert is configured to resist rotation of the at least one tray table arm when the tray table is rotated away from the stowage compartment.

19. A tray table assembly comprising:
a tray table configured to stow within a stowage compartment;
a tray table arm pivotally coupled to the tray table proximate a first pivot location; and
the tray table arm pivotally coupled to the stowage compartment proximate a second pivot location;
wherein a torque insert is positioned within the second pivot location.

20. The tray table assembly of claim 19, wherein the torque insert positioned within the second pivot location is configured to resist rotation of the tray table arm when the tray table is rotated into the stowage compartment and to also resist rotation of the tray table arm when the tray table is rotated away from the stowage compartment.
